(19) United States
(12) Patent Application Publication
(10) Pub. No.: US 2011/0285686 A1
(43) Pub. Date: Nov. 24, 2011

(54) IMAGE DISPLAY APPARATUS

(75) Inventors: Tomonori Nakazawa, Atsugi-shi (JP); Kinya Kamiguchi, Kamakura-shi (JP)

(73) Assignee: CANON KABUSHIKI KAISHA, Tokyo (JP)

(21) Appl. No.: 13/101,076

(22) Filed: May 4, 2011

(30) Foreign Application Priority Data
May 20, 2010 (JP) 2010-116430

(51) Int. Cl. G06F 3/038

(52) U.S. Cl. 345/211

(57) ABSTRACT

A display apparatus includes: a first insulating substrate provided with a cathode and a through hole; a second insulating substrate provided with an anode to which a voltage for accelerating the electron emitted from the cathode is applied; a voltage application structure connected to the anode through the through hole, configured to apply the voltage to the anode; and a first potential regulation structure that is provided in such a manner to enclose the through hole on a first face of the first insulating substrate and regulated at a lower potential than that of the anode. A second potential regulation structure that is in contact with a wall surface constituting the through hole therein and regulates a potential of a contact portion with the wall surface at a voltage same as that of the voltage application structure.

### BACKGROUND OF THE INVENTION

1. Field of the Invention

The present invention relates to an image display apparatus including a flat type display panel.

2. Description of the Related Art

As an image display apparatus of a flat type, an image display apparatus (hereinafter, referred to as a “field emission display (FED)”) using an electron emitting device of a field emission type as discussed in Japanese Patent Application Laid-Open No. 05-114372 and an image display apparatus (hereinafter, referred to as a “surface-conduction electron-emitter display (SED)”) using an electron emitting device of a surface-conduction electron-emitter type as discussed in Japanese Patent Application Laid-Open No. 09-045266 are known.

In such a flat type image display apparatus, a high voltage is applied between two pieces of glass substrates (a rear plate on which an electron emitting device is formed and a face plate on which an image forming member is formed). As described above, an electron emitted from the electron emitting device at a desired position is made to collide with the image forming member on the face plate, and then the image forming member is made to emit light to display an image.

The flat type image display apparatus described above has a voltage application structure for applying the high voltage to the image forming member. When abnormal discharge occurs in a part of the voltage application structure, it may cause a display defect of an image or a trouble of the image display apparatus. Therefore, a technique is known for providing a potential regulation structure or a dielectric strength voltage structure as a structure for preventing the abnormal discharge from occurring in the voltage application structure (refer to Japanese Patent Application Laid-Open No. 2006-93168).

The Japanese Patent Application Laid-Open No. 2005-251761 discusses a through hole structure in which a conductive layer is provided on a surface of the rear plate as the potential regulation structure at the periphery of the voltage application structure for applying the voltage to an anode.

Further, the Japanese Patent Application Laid-Open No. 2006-222093 discusses that as the dielectric strength voltage structure, convex and concave portions are formed on the surface of the rear plate at the periphery of the through hole through which the voltage application structure is inserted to prevent the abnormal discharge.

In the conventional flat type image display apparatus using the electron emitting device, the voltage application structure for applying the voltage to the anode at a faceplate side includes the conductive member inserted through the through hole provided in the rear plate. To prevent the abnormal discharge from occurring at the periphery of the voltage application structure to which the high voltage is applied, the potential regulation structure to regulate a predetermined potential on the surface of the rear plate is provided.

Thus, due to restrictions imposed by voltage strength that the potential regulation structure has, it is difficult to reduce a size of the potential regulation structure in a face of the rear plate, thereby hindering the downsize downsizing of the image display apparatus. Further, such a voltage application structure and a potential regulation structure are generally disposed outside of the image display region not to interfere with the image display. Therefore, it has been difficult to reduce a distance (hereinafter, referred to as a “frame distance”) from an end portion of the image display region to an end portion of the rear plate.

### SUMMARY OF THE INVENTION

According to an aspect of the present invention, a display apparatus includes a first insulating substrate provided with a cathode that emits an electron and a through hole; a second insulating substrate that faces a first face of the first insulating substrate and is provided with an anode to which a voltage for accelerating the electron is applied; a voltage application structure connected to the anode through the through hole, configured to apply the voltage to the anode; and a first potential regulation structure configured to enclose the through hole on the first face of the first insulating substrate and regulated at a lower potential than that of the anode. The voltage application structure includes a second potential regulation structure that is in contact with a wall surface constituting the through hole therein and regulates a potential of a contact portion with the wall surface at a voltage same as that of a voltage application structure.

According to another aspect of the present invention, a second potential regulation structure for regulating a potential at the periphery of a through hole is provided inside the through hole disposed in the first insulating substrate. Thus, a conductive member for preventing abnormal discharge does not have to be formed on a surface of the first insulating substrate at the periphery of the through hole. With this arrangement, the potential regulation structure having a small size within a face of the first insulating substrate can be provided.

Further, on a creeping passage along a surface of a first insulating substrate between a first potential regulation structure having a lower potential than that of an anode and a second potential regulation structure having a substantially equal potential to that of the anode, an edge of an opening end portion of a wall portion forming a through hole is located.

With this arrangement, since creeping voltage proof performance obtained by a creeping barrier effect can be improved, a size of the first voltage feed structure within the rear plate face can be also reduced.

With the effects described above, the voltage application structure appropriate for the image display apparatus having a short frame distance can be obtained.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A, 1B, and 1C are respectively a general perspective view of an image display apparatus, and a general plan view and a general elevational, cross-sectional view of a voltage application structure and at the periphery thereof according to a first exemplary embodiment of the present invention.

FIGS. 2A and 2B are respectively a general plan view and a general elevational, cross-sectional view of a voltage application structure and at the periphery thereof according to a second exemplary embodiment of the present invention.

FIGS. 3A, 3B, 3C, and 3D generally illustrate exemplary examples of a second potential regulation structure according to the present invention.

### DESCRIPTION OF THE EMBODIMENTS

Various exemplary embodiments, features, and aspects of the invention will be described in detail below with reference to the drawings.

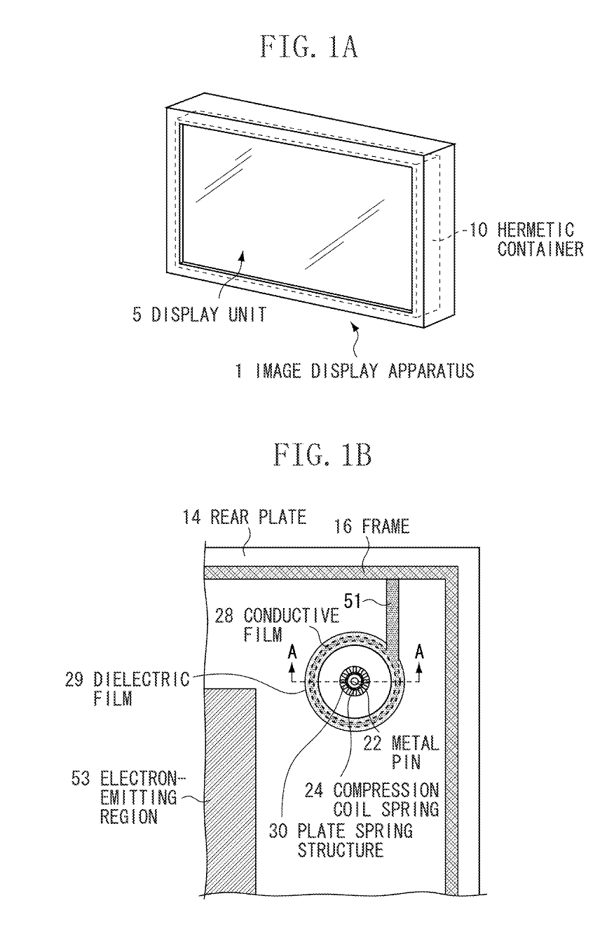

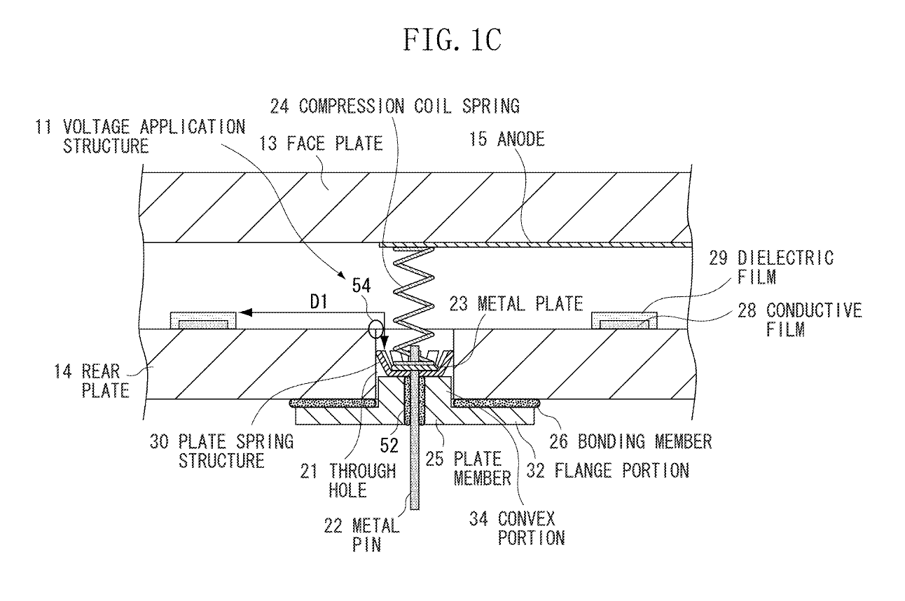

As illustrated in FIG. 1A, an image display apparatus 1 of a first exemplary embodiment includes a display unit 5 for displaying each information such as characters and images. Further, the image display apparatus 1 includes a control unit (not illustrated) for driving and controlling the display unit 5, a support frame (not illustrated) for supporting the display unit 5 and the control unit, and a cover (not illustrated), which is a case for covering the display unit 5, the control unit, and the support frame.

As illustrated in FIGS. 1B and 1C, the display unit 5 includes a hermetic container 10 whose inside is maintained hermetic and a voltage application structure 11 serving as a power feeding structure for feeding a potential from the outside into the hermetic container 10.

FIG. 1B is a plan view illustrating a part of the inside of a rear plate (first insulating substrate) 14 constituting the hermetic container 10. FIG. 1C is a general elevational, cross-sectional view illustrating the hermetic container 10 taken along the line A-A illustrated in FIG. 1B.

As illustrated in FIGS. 1C, the hermetic container 10 includes a face plate (second insulating substrate) 13, a rear plate 14, and a frame 16. The face plate 13 is opposed to the rear plate 14. The face plate 13 is provided with an anode 15 on a face facing inside of the hermetic container 10. On a face (first face) of the rear plate 14 opposing the face plate 13, an electron emission region 53 including a plurality of cathodes (electron emitting devices) for emitting the electrons is provided. The frame 16 is inserted into a space sandwiched between the faceplate 13 and the rear plate 14 which are provided opposing each other. A voltage for accelerating electrons emitted from the electron emission region 53 is applied to the anode 15.

The face plate 13 and the rear plate 14 are formed of, for example, a glass material having a thermal expansion coefficient of 8.0×10⁻⁶ to 9.0×10^{-6/}° C. and a thickness of about 1.8 mm. The frame 16 is formed of, for example, similar glass material to that forming the face plate 13 and rear plate 14, and has a thickness of 1.1 mm for example. The frame 16 is provided by bonding between the faceplate 13 and the rear plate 14.

The face plate 13, the rear plate 14, and the frame 16 are bonded to one another using, for example, a frit (not illustrated), and a space between the faceplate 13 and the rear plate 14 are ensured to be hermetic. The inside of the hermetic container 10 is maintained in a vacuum state or a reduced pressure state.

The voltage application structure 11 for applying the voltage to the anode 15 is inserted through a through hole 21 provided in the rear plate 14. The voltage application structure 11 includes at least a first conductive elastic member 24 that abuts on the face plate 13 (anode 15) and a second conductive elastic member 30 that abuts on an inner wall of the through hole 21.

More specifically, as illustrated in FIG. 1C, the voltage application structure 11 includes a conductive pin (herein, a metal pin) 22, a conductive plate (herein, a metal plate) 23, and the first conductive elastic member (herein, a compression coil spring) 24, and the second conductive elastic member (herein, a plate spring structure) 30. The second conductive elastic member 30 may be integrally formed of a conductive plate 23.

The metal pin 22, which is a conductive pin, is inserted into the through hole 21 provided on the rear plate 14 to feed the potential for applying a predetermined potential (practically equal to or more than 10 kV and equal to or less than 30 kV) to the anode 15 in the hermetic container 10. The metal plate 23, which is a conductive plate, is electrically connected to the metal pin 22. One end portion of the compression coil spring 24, which is a first conductive elastic member, is electrically connected to the metal plate 23, and another end is electrically connected to the anode 15.

The compression coil spring 24 extends toward the anode 15 on the face plate 13 from the through hole 21 and is biased toward the anode 15. As described above, the metal pin 22, the metal plate 23, and the compression coil spring 24 included in the voltage application structure 11 are electrically connected to the anode 15 through the through hole 21 to apply the voltage to the anode 15.

The voltage application structure 11 includes a plate spring structure 30 serving as a second potential regulation structure that is electrically connected to the metal pin 22 and in contact with a wall face constituting the through hole 21 therein. Further, a conductive film 28 serving as a first potential regulation structure is provided on a first face (hereinafter, referred to as an “inner face” of the rear plate 14) of the rear plate 14 opposing the face plate 13 in such a manner to enclose the through hole 21 as illustrated in FIGS. 1B and 1C. The conductive film 28 is regulated to have a potential (typically, ground potential) lower than that of the anode 15.

Furthermore, the image display apparatus 1 includes a plate member 25 that is bonded to the metal pin 22 and the rear plate 14 to seal the through hole 21, and bonding members 26 and 52 for bonding the plate member 25 to the rear plate 14 and the metal pin 22 respectively.

The through hole 21 is formed to have a diameter of about 2 mm. The conductive film 28 is formed in a circular pattern having an inner diameter of about 5.4 mm, made of a metal thin film, and formed by a film coating process such as a mask film coating and a photo lithography method.

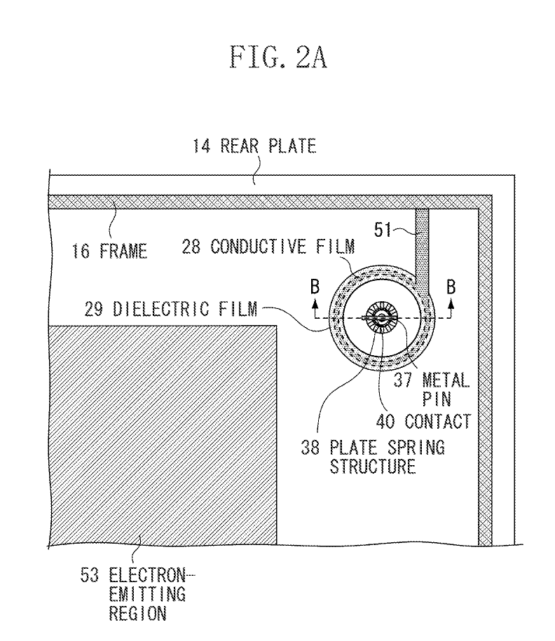

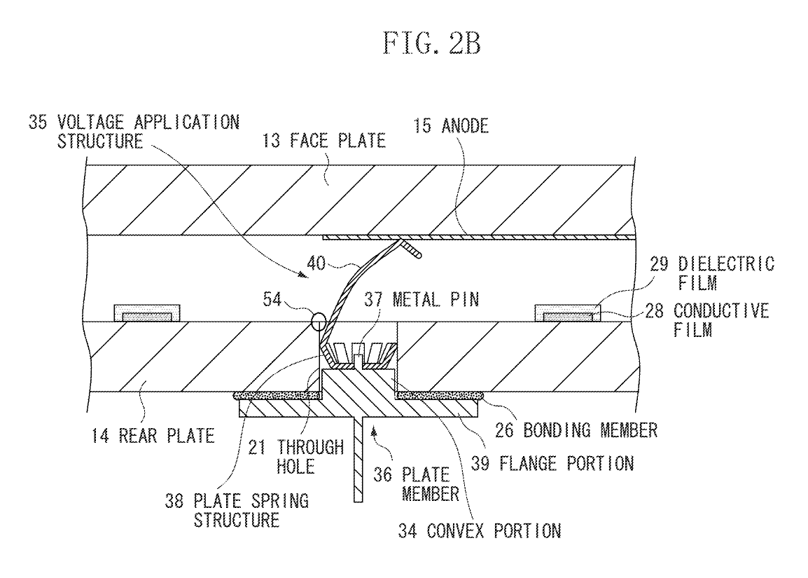

A dielectric film 29 made of glass frit or polyimide may be provided in such a manner to cover the conductive film 28 to prevent the electrons from discharging from a electric field concentrated point (e.g., sharp-pointed portion) of the conductive film 28. In FIG. 1B, for the sake of convenience, the conductive film 28 covered with the dielectric film 29 is illustrated with a dotted line, and the same in FIG. 2A.

The metal pin 22, a part of which is provided in the through hole 21, is bonded to the rear plate with the bonding member 52, such as a frit for hermetically clogging the through hole 21 together with the metal pin 22, that is provided at least between the wall face constituting the through hole 21 and the metal pin 22. According to an example described herein, the conductive pin (metal pin) 22 is sealed and bonded by the plate member 25 and the bonding member 52 such as the frit, with the metal pin 22 inserted into a hole provided in the plate member 25.

The metal pin 22 can be made from a material of, for example, 42Ni-6Cr—Fe alloy (thermal expansion coefficient: 7.5×10⁻⁶ to 9.8×10^{-6/}° C.). Herein, the metal pin made from 42Ni-6Cr—Fe alloy having the thermal expansion coefficient of 9.0×10^{-6/}° C. is used. The metal pin 22 is formed to have a diameter of about 0.5 mm.

Further, the plate member 25 can be made of a material such as a glass material having the thermal expansion coefficient of 8.0×10⁻⁶ to 9.0×10^{-6/}° C. Thermal expansion of the metal pin 22 and the plate member 25 is made substantially equal to that of the glass material (thermal expansion coefficient: 9.0×10^{-6/}° C.) forming the rear plate 14 to reduce a thermal stress generated at the sealing bonding portion.

The metal pin 22 can use as a material, for example, invar alloy, 47Ni—Fe alloy (thermal expansion coefficient: 3.0×10⁻⁶ to 5.5×10^{-6/}° C.), and 42Ni-6Cr—Fe alloy (thermal expansion coefficient: 7.5×10⁻⁶ to 9.8×10^{-6/}° C.). It is useful that the material of the metal pin 22 is appropriately selected according to the thermal expansion coefficient (5.0×10⁻⁶ to 9.0×10^{-6/}° C.) of the glass material to be used for the rear plate 14. It is useful that the metal pin 22 use a metal material having the thermal expansion coefficient of 2.0×10⁻⁶ to 12.0×10^{-6/}° C. so that an absolute value of a difference between the thermal expansion coefficients of the metal pin 22 and the rear plate 14 is equal to or less than 3.0×10^{-6/}° C.

The plate member 25 can use as a material, for example, glass, invar alloy, 47Ni—Fe alloy, or 42Ni-6Cr—Fe alloy. The thermal expansion coefficient is 8.0×10⁻⁶ to 9.0×10^{-6/}° C. for the glass, 3.0×10⁻⁶ to 5.5×10^{-6/}° C. for the 47Ni—Fe alloy and 7.5×10⁻⁶ to 9.8×10^{-6/}° C. for the 42Ni-6Cr—Fe alloy is. It is useful that a material of the plate member 25 is appropriately selected according to the thermal expansion coefficient (5.0×10⁻⁶ to 9.0×10^{-6/}° C.) of the glass material used for the rear plate 14.

It is useful that the plate member 25 is appropriately selected from materials having the thermal expansion coefficient of 2.0×10⁻⁶ to 12.0×10^{-6/}° C. so that an absolute value of a difference between the thermal expansion coefficients of the plate member 25 and the rear plate 14 is equal to or less than 3.0×10^{-6/}° C.

Further, it is useful that, on surfaces of the metal pin 22 and the plate member 25, a surface film (not illustrated) is formed to improve a bonding strength with the bonding member 52. For the surface film, for example, a metal oxide film can be used when the frit is used as the bonding member 52 and conductive plating can be used when metal having a low melting point is used. It is useful to select the surface film considering ease of wetting and bonding with the bonding member 52.

According to an example described here, the plate member 25 includes a flange portion 32, which is bonded onto an outer surface of the rear plate 14 with the bonding member 26. The plate member 25 is formed, for example, in a convex structure portion 34 which is about 1.8 mm in diameter, and thus, a positioning of the plate member 25 relative to the through hole 21 can be easily performed. Further, according to the present invention, the plate member 25 may be a flat plate including no flange portion.

As the bonding member 26, a frit can be used. For the bonding member 26, considering a material of the plate member 25 and wettability with the surface film (not illustrated) provided on the plate member 25, it is useful to appropriately select from the materials of, for example, frit, indium, and lead solder.

The compression coil spring 24, which is the first conductive elastic member, is bonded to one face of the metal plate 23 by, for example, laser spot welding. The compression coil spring 24 is formed of a stainless steel wire which is 0.06 mm in diameter, 5 mm in natural length, and 1 mm in outer diameter. By adopting a structure of the compression coil spring 24, the voltage application structure 11 can obtain a comparatively large stroke by making a spring pitch larger, even a length of the spring is short. Thus, even in a comparatively small area, which is unique to the thin flat type image display apparatus 1, an elastic force of the compression coil spring 24 can stably function.

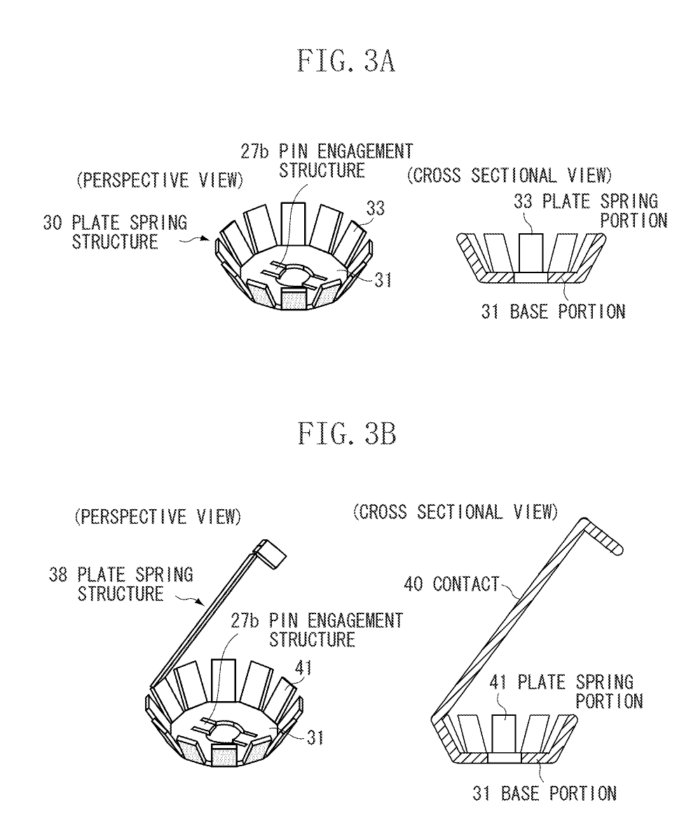

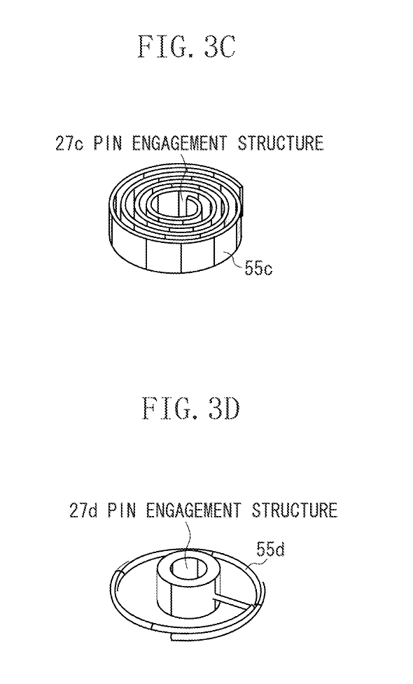

The metal plate 23, which is a conductive plate, is produced by, for example, performing etching processing on a stainless plate which is 1.2 mm in diameter and 0.05 mm in thickness, and has a pin engagement structure 27b in which the metal pin 22 is inserted to be electrically connected to the metal plate 23 (refer to FIG. 3 also). The metal plate 23 is positioned by engaging with the metal pin 22, and pushed to a side of the rear plate 14 by the compression coil spring 24 to be welded to the face plate 13 after the face plate 13 is installed. With this arrangement, the metal plate 23 is positioned more accurately.

A plate spring structure 30, which is the second conductive elastic member, is produced by performing sheet-metal processing on the stainless plate on which the etching processing is performed. FIG. 3A includes a perspective view and an elevational, cross-sectional view of the plate spring structure 30. The plate spring structure 30 includes a base portion 31 and a plate spring portion 33 including a plurality of plate springs extending from the base portion 31.

The base portion 31 is formed in, for example, a substantially circular plate shape which is 1.4 mm in diameter and has a pin engagement structure 27b in which the metal pin 22 is inserted to be electrically connected to the base portion 31. The plate spring portion 33 is formed in, for example, a rectangular shape which is about 0.55 mm in length and about 0.3 mm in width, and twelve plate spring portions 33 are arranged at a uniform pitch at a circumferential portion of the base portion 31. Each plate spring portion 33 is provided at an angle of 30 degrees with respect to a surface of the base portion 31.

The base portion 31 of the plate spring structure 30 is sandwiched between the plate member 25 and the metal plate 23, and engaged with the metal pin 22. The plate spring structure 30 is disposed inside the through hole 21. The plate spring portion 33 is in contact with the wall face constituting the through hole 21 to regulate the potential of the wall face. According to the present exemplary embodiment, a plurality of plate spring portions (contact portions) 33 are in contact with almost one round of the wall face constituting the through hole 21 in a circumferential direction at a predetermined pitch. The plate spring portion 33 is in contact with the wall face constituting the through hole 21 at a position about 0.5 mm away from an end portion of the through hole 21 at an inner face side (first face side) of the rear plate 14.

With this arrangement, in an arbitrary direction from the through hole 21, the abnormal discharge can be reduced. Further, the plate spring structure 30 can provide enhanced contact with the wall surface constituting the through hole 21. According to the present exemplary embodiment, the plate spring portion 33 and the wall face of the through hole 21 are in contact with each other at the position about 0.5 mm away from the end portion of the through hole 21 at the inner face side of the rear plate 14. Moreover, since the plate spring portion 33 of the plate spring structure 30 is biased toward the wall surface constituting the through hole 21, the plate spring portion 33 can provide further enhanced contact with the wall face.

It is useful that the plate spring structure 30 is made of the material, for example, stainless steel, carbon steel, and heat resistant alloy, which is appropriately selected considering heat resistance during heating processing included in production process performed by the image display apparatus 1. Further, the plate spring structure 30 and the rear plate 14 are in contact with each other only on the wall surface of the through hole 21.

In the voltage application structure 11 constituted as described above, the voltage is applied from an outer face side of the rear plate 14, in other words, from the outside of the hermetic container, to the anode 15, through the metal pin 22 inserted into the through hole 21, and passing through the metal plate 23 and the compression coil spring 24.

By applying the voltage to the anode 15, the electron emitted from the electron emission region 53 provided on the rear plate 14 is accelerated and collides with a fluorescent material provided as the anode 15. As described above, by causing the fluorescent material to emit light, information such as images is displayed on the display unit 5 included in the image display apparatus 1.

In the above-described voltage application structure 11, since the plate spring structure (second potential regulation structure) 30 engaged with the metal pin 22 to which the voltage is applied is in contact with the wall surface constituting the through hole 21, the potential on the wall surface can be regulated. Further, the conductive film 28, which is the first potential regulation structure, formed on the rear plate 14 is preferably grounded through a leading wiring 51 to determine a potential reference.

Furthermore, the conductive film 28 determining the potential reference encloses a periphery of the voltage application structure 11 to which the high voltage is applied, so that the potential can be stable in the entire voltage application structure 11. Therefore, the abnormal discharge can be suppressed at the periphery of the voltage application structure 11. The conductive film 28 serving as the first potential regulation structure does not have to be necessarily grounded, but may be regulated to a lower potential than that of the anode 15.

It is generally considered that creeping discharge along a surface of the member disposed in vacuum is caused by a secondary electron emission avalanche (SEEA). When the electrons are emitted from the electric field concentration portion formed at a boundary between a negative electrode and an insulation member, and a vacuum portion, a part of the electrons collides with a surface of the insulation member and then emits the secondary electrons.

At this point, if energy of the electron that collides has a certain level of a power, a secondary electron emission coefficient of the insulation member is larger than “1” and the number of emitted electrons is larger than that of entering electrons. Thus, a surface of the insulation member is charged positive. In such a manner, the potential on the surface of the insulation member is raised to prompt the electrons to further emit from the above-described field concentration portion. By repeating this process, the creeping discharge is generated.

In the voltage application structure 11 described above, between the conductive film 28 that is the negative electrode and the plate spring structure 30 that is a positive electrode, an edge 54 of the rear plate 14 corresponding to an opening end portion of the through hole 21 is located. More specifically, the creeping passage (passage indicated by a distance D1 illustrated in FIG. 1C) along the surface of the rear plate 14 between the conductive film 28 and the plate spring structure 30 is formed in a convex shape protruding from a straight line connecting the negative electrode and the positive electrode.

Therefore, since the electron emitted from the field concentration portion of the conductive film 28 flies toward the surface (the edge 54 of a rear plate) of the rear plate 14, a range until the electron collides with the rear plate 14 becomes short. Accordingly, the energy obtained from the electric field until the electron collides is decreased to lower the collision energy of the electron, and thus the secondary emission coefficient becomes smaller. As a result, the SEEA can be suppressed (creeping barrier effect).

By such a creeping barrier effect, the dielectric strength voltage performance is improved at the creeping passage, and the discharge can be sufficiently suppressed even though the creeping passage is short. Thus, the conductive film 28 serving as the first potential regulation structure can be reduced in size within the face of the rear plate 14.

The plate spring structure 30 that regulates the potential at the periphery of the through hole 21 is stored in the through hole 21, and thus, the conductive member for preventing the abnormal discharge does not have to be formed on the surface of the rear plate 14 near the through hole 21. With this arrangement, the potential regulation structures 28 and 30 can be further reduced in size within the face of the rear plate 14.

According to the present exemplary embodiment, as illustrated in FIGS. 2A and 2B, the voltage application structure 11 and the first and second potential regulation structures 28 and 30 are located outside the image display area, in other words, the electron emission region 53. Therefore, by reducing a size of the potential regulation structures 28 and 30, a distance (frame distance) from the end portion of the image display region to the end portion of the rear plate 14 can be also decreased.

When a creeping distance of the creeping passage along the surface of the rear plate 14 is defined as D1, the potential of the conductive film 28 is defined as V1, the potential of the plate spring structure 30 is defined as V2, and the dielectric strength voltage is defined as E1, it is useful to satisfy “D1>(V2−V1)/E1”. If it is satisfied, the creeping discharge can be prevented from occurring along the creeping passage on the surface of the rear plate 14.

Further, the shortest space distance between the end portion of the wall surface constituting the through hole 21 at the inner face side of the rear plate 14 and the voltage application structure 11 is defined as D2. When, practically, the potential of the plate spring structure 30 is defined as V2, the potential of the end portion of the wall surface is defined as V3, and the dielectric strength voltage of the space between the end portion of the wall surface and the voltage application structure 11 is defined as E2, it is useful to satisfy “D2>(V2−V3)/E2”. If it is satisfied, the discharge between the voltage application structure 11 and the rear plate 14 can be prevented.

As illustrated in FIGS. 2A and 2B, the image display apparatus of a second exemplary embodiment includes the hermetic container 10 having the same structure as that of the first exemplary embodiment and a voltage application structure 35 serving as a power feeding structure for feeding the potential from the outside into the hermetic container 10. FIG. 2B is an elevational, cross-sectional view of the hermetic container 10 taken along the line B-B illustrated in FIG. 2A.

As illustrated in FIG. 2B, the hermetic container 10 includes the face plate (second insulating plate) 13 on which the anodes 15 are provided all over, the rear plate (first insulating plate) 14 provided with the electron emission region 53 on a face opposing the face plate 13. Further, the hermetic container 10 includes the frame 16 sandwiched between the face plate 13 and the rear plate 14.

As illustrated in FIG. 2B, the voltage application structure 35 according to the second exemplary embodiment includes a plate member 36 made of the conductive material, a metal pin 37, and a plate spring structure 38. The plate member 36 is bonded to the rear plate 14 and seals the through hole 21 provided in the rear plate 14. The metal pin 37 is provided at the plate member 36 and located in the through hole 21. The plate spring structure 38 is electrically connected to the metal pin 37, in contact with the wall surface constituting the through hole 21, and regulates the wall surface with the same potential as that of the plate spring structure 38. As described above, the plate spring structure 38 provided for the voltage application structure 35 constitutes the second potential regulation structure. The plate member 36 and the rear plate 14 are bonded to each other with the bonding member 26.

Further, the conductive film 28 serving as the first potential regulation structure is provided at the inner face of the rear plate 14 opposing the face plate 13 to enclose the through hole 21 as illustrated in FIGS. 2A and 2B. The conductive film 28 is regulated with the lower potential than that of the anode 15. Furthermore, similarly to the first exemplary embodiment, it is useful to form the dielectric film 29 made of the glass frit to cover the conductive film 28. As to the structure similar to the first exemplary embodiment, the materials and the sizes can be defined to be similar too. Moreover, the structures and the materials of the plate member 36 and the metal pin 37 can be the same as those of the plate member 25 and the metal pin 22 described in the first exemplary embodiment.

The plate member 36 includes a flange portion 39, which is bonded onto the outer face of the rear plate 14 with the bonding member 26. The plate member 36 includes a convex structure portion 34, and the convex structure portion 34 and the through hole 21 are positioned and then bonded to the rear plate 14.

The plate spring structure 38 is produced by, for example, performing sheet-metal processing on the stainless plate on which the etching processing has been performed. As illustrated in FIG. 3B, the plate spring structure 38 includes a base portion 31 and a plate spring portion 41 including a plurality of plate springs extending from the base portion 31. The base portion 31 is formed in, for example, a circular plate shape having a diameter of about rear plate 1.4 mm and has a pin engagement structure 27b in which the metal pin 37 is inserted to be electrically connected to the base portion 31. The plate spring portion 41 is formed in, for example, a rectangular shape which is about 0.55 mm in length and about 0.3 mm in width, and twelve plate spring portions 41 are arranged at a uniform pitch at a circumferential portion of the base portion 31 . Each plate spring portion 41 is provided at an angle of 30 degrees with respect to a face of the base portion 31.

Further, the plate spring structure 38 includes a contact 40 for electrically connecting with the anode 15. The contact 40 is formed of the rectangular plate spring extending from at least one of a plurality of plate spring portions 41. The contact 40 is formed to be, for example, about 0.3 mm in width, about 3.0 mm in length, and about 60 degrees in angle with respect to the plate spring portion 41. The contact 40 extends toward the anode 15 from the through hole 21, elastically deforms, is in contact with the anode 15 with some level of contact resistance, and biased toward the anode 15. It is useful that an elasticity of the contact 40 is designed to stabilize the contact resistance and set a contact pressure to more than a predetermined value.

The plate spring structure 38 is engaged with the metal pin 37 and provided in the through hole 21. The plate spring portion 41 is in contact with the wall surface constituting the through hole 21. According to the present exemplary embodiment, a plurality of plate spring portions (contact portions) 41 are in contact with almost one round of the wall face constituting the through hole 21 in the circumferential direction at a predetermined pitch. The plate spring portion 41 is in contact with the wall surface constituting the through hole 21 at the position about 0.5 mm away from the end portion of the through hole 21 at the inner face side of the rear plate 14. Since the plate spring portion 41 of the plate spring structure 38 is biased toward the wall surface constituting the through hole 21, the plate spring portion 41 can provide the enhanced contact with the wall face.

It is useful that the plate spring structure 38 be made of, for example, stainless steel, carbon steel, and heat resistant alloy, which is appropriately selected considering heat resistance during heating processing included in production process of the image display apparatus 1.

In the voltage application structure 35 constituted as described above, the voltage is applied from the outer face side of the rear plate 14 to the anode 15, through the conductive plate member 36 inserted into the through hole 21, and passing through the plate spring structure 38.

By applying the voltage to the anode 15, the electron emitted from the electron emission region 53 provided on the rear plate 14 is accelerated and collides with a fluorescent material provided as the anode 15. The collision causes the fluorescent material to emit light, and then the information such as the images are displayed on the display unit 5 included in the image display apparatus 1.

In the above-described voltage application structure 35, since the plate spring structure 38 engaged with the metal pin 37 to which the voltage is applied is in contact with the wall surface constituting the through hole 21, the potential of the wall surface can be regulated. Further, the conductive film 28, which is the first potential regulation structure, is preferably grounded to determine a potential reference. Furthermore, the conductive film 28 encloses the voltage application structure 35 to which the high voltage is applied, so that the potential can be stable in the entire voltage application structure 35. Therefore, the abnormal discharge can be suppressed at the periphery of the voltage application structure 35.

In the voltage application structure 35 described above, between the conductive film 28 that is the negative electrode and the plate spring structure 38 that is a positive electrode, an edge 54 of the rear plate 14 corresponding to the opening end portion of the through hole 21 is located. More specifically, the creeping passage along the surface of the rear plate 14 is formed in a protruding shape protruding from the straight line connecting the negative electrode and the positive electrode.

Therefore, a range of the electron emitted from the field concentration portion of the conductive film 28 until the electron collides with the rear plate 14 is short, and the energy obtained from the field is small. Accordingly, the collision energy of the electron is decreased, and thus the secondary emission coefficient becomes smaller. As a result, the SEEA can be suppressed (creeping barrier effect).

By such a creeping barrier effect, the dielectric strength voltage performance is improved at the creeping passage, and the potential regulation structures 28 and 38 can be reduced in size within the face of the rear plate 14.

The plate spring structures 30 and 38 described in the first and second exemplary embodiments are not limited thereto, as long as having the similar functions. For example, as illustrated in FIGS. 3C and 3D, the plate spring structure may include a pin engagement structures 27c and 27d that engage with the metal pins 22 and 37, and contact portions 55c and 55d that are electrically connected to the pin engagement structures and in contact with the wall surface constituting the through hole 21. As illustrated in FIGS. 3C and 3D, the plate spring structure serving as the second potential regulation structure can be continuously in contact with the entire circumference (or, almost entire circumference) of the wall surface constituting the through hole 21 in the circumferential direction. As described above, it is particularly useful that the second conductive elastic member abuts on all the round (or, almost all the round) of the wall surface constituting the through hole 21 in the circumferential direction, since variation of the potential on the wall surface of the through hole 21 can be decreased.

The preferable exemplary embodiment of the present invention is proposed thus far, and described in detail. Many other embodiments and modifications may be made without departing from the spirit and scope of the invention as defined in the claims. The present invention can be appropriately applied to various kinds of image display apparatuses such as the field emission display using an electron emitting device and surface-conduction electron-emitter display using an electron emitting device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-116430 filed May 20, 2010, which is hereby incorporated by reference herein in its entirety.

What is claimed is:

1. A display apparatus comprising:
a first insulating substrate provided with a cathode that emits an electron and a through hole;
a second insulating substrate that faces a first face of the first insulating substrate and is provided with an anode to which a voltage for accelerating the electron is applied;
a voltage application structure connected to the anode through the through hole, configured to apply the voltage to the anode; and
a first potential regulation structure configured to enclose the through hole on the first face of the first insulating substrate and regulated at a lower potential than that of the anode,
wherein the voltage application structure includes a second potential regulation structure that is in contact with a wall surface constituting the through hole therein and regulates a potential of a contact portion with the wall surface at a voltage same as that of a voltage application structure.

2. The display apparatus according to claim 1, wherein the second potential regulation structure includes a plurality of contact portions that contact the wall surface in a circumferential direction at a predetermined pitch.

3. The display apparatus according to claim 1, wherein the second potential regulation structure is continuously in contact with all a round of the wall surface in a circumferential direction.

4. The display apparatus according to claim 1, wherein, when a creeping distance along a surface of the first insulating substrate between the first potential regulation structure and the second potential regulation structure is defined as D1, a potential of the first potential regulation structure is defined as V1, a potential of the second potential regulation structure is defined as V2, and a dielectric strength voltage of a portion constituting the creeping distance is defined as E1, “D1>(V2−V1)/E1” is satisfied.

5. The display apparatus according to claim 1, wherein, when a shortest space distance between an end portion of the wall surface at aside of the first face of the first insulating substrate and the voltage application structure is defined as D2, a potential of the second potential regulation structure is defined as V2, a potential of the end portion of the wall surface is defined as V3, and a dielectric strength voltage of the space between the end portion of the wall surface and the voltage application structure is defined as E2, “D2>(V2−V3)/E2” is satisfied.

6. The display apparatus according to claim 1, wherein the voltage application structure includes a first conductive elastic member that extends toward the anode provided on the second insulating substrate from the through hole and is biased toward the anode.

7. The display apparatus according to claim 1, wherein the second potential regulation structure includes a second conductive elastic member that is in contact with the wall surface constituting the through hole and biased toward the wall surface.
